(19) United States
(12) Patent Application Publication
(10) Pub. No.: US 2025/0377723 A1
(43) Pub. Date: Dec. 11, 2025

(54) Maintaining User Representation Appearance during Device Removal

(71) Applicant: Apple Inc., Cupertino, CA (US)

(72) Inventors: Magnus H. Johnson, San Francisco, CA (US); Sebastian P. Herscher, San Francisco, CA (US); Yeunju A. Kim, Mountain View, CA (US)

(21) Appl. No.: 19/224,830

(22) Filed: Jun. 1, 2025

Related U.S. Application Data
(60) Provisional application No. 63/657,705, filed on Jun. 7, 2024.

(51) Int. Cl. G06F 3/01; G02B 27/00

(52) U.S. Cl. CPC G06F 3/013; G02B 27/0093

(57) ABSTRACT

Various implementations disclosed herein include devices, systems, and methods that use sensor data to recognize circumstances in which a user representation should be configured to account for head-mounted device (HMD) doffing or other removal from normal use position, e.g., ensuring that the user representation is not deformed or otherwise changed in an unnatural/undesirable way based on the images or other sensor data of the user's eyes and/or other face portions not being captured from expected capture positions as the device is doffed or otherwise removed from its normal use position. As examples, this may involve using motion sensor data to detect device changes in position and/or orientation and/or image sensor data to determine when the user's eye (whether open or closed) is present within the eye box region of the device.

### CROSS-REFERENCE TO RELATED APPLICATIONS

This Application claims the benefit of U.S. Provisional Application Ser. No. 63/657,705 filed Jun. 7, 2024, which is incorporated herein in its entirety.

### TECHNICAL FIELD

The present disclosure generally relates to electronic devices, and in particular, to systems, methods, and devices for representing the appearances of users based on images and other sensor data.

### BACKGROUND

Existing techniques may not adequately provide avatars or other user representations representing the appearances of users of electronic devices in various circumstances. For example, user representations may be presented in circumstances in which the sensor data upon which a user representation is based is interrupted by a user activity, such as by a user doffing or otherwise removing a wearable device having the sensors providing such sensor data.

### SUMMARY

Various implementations disclosed herein include devices, systems, and methods that use sensor data to recognize circumstances in which a user representation should be configured to account for head-mounted device (HMD) doffing or other removal from normal use position, e.g., ensuring that the user representation is not deformed or otherwise changed in an unnatural/undesirable way based on the images or other sensor data of the user's eyes and/or other face portions not being captured from expected capture positions as the device is doffed or otherwise removed from its normal use position. As examples, this may involve using motion sensor data to detect device changes in position and/or orientation and/or image sensor data to determine when the user's eye (whether open or closed) is present within the eye box region of the device and/or to determine abnormal positioning of one or both eyes relative to the device, e.g., both eyes appearing in sensor data to have simultaneously moved down (which may occur for example when the device starts moving up relative to the user's face). Such determinations may be made promptly, e.g., as soon as such lack of eye presence or abnormal positioning occurs, e.g., right when the user is starting to move the device (e.g., moving the device upward) from its normal position, and an appropriate mitigation promptly performed. The user representation's appearance may be configured (e.g., altered) in such scenarios, for example, by freezing the current appearance of the user representation (e.g., the head of the user's avatar) and/or displaying a fixed user representation appearance (e.g., displaying a neutral avatar appearance based on a pre-session/enrollment neutral avatar appearance).

In general, one innovative aspect of the subject matter described in this specification can be embodied in a method performed by a processor (e.g., on an HMD) executing instructions embodied in a non-transitory computer-readable medium. The method may involve obtaining sensor data via the one or more sensors during a period of time. The method may involve determining a removal (e.g., doffing or taking off) of the HMD during the period of time based on the sensor data. The removal of the HMD corresponds to a change of the HMD from a first position at which one or more displays of the HMD are positioned in front of eyes of a user (e.g., a normal use position) to a second position at which the one or more displays are positioned elsewhere with respect to the user (e.g., a doffed or taken off position). Removal may involve the device's position changing from its normal use position in front of the user's eyes to a taken off or doffed position. The method further involves generating user representation data corresponding to a three-dimensional (3D) appearance of the user during the period of time based on the sensor data, wherein the user representation data is generated based on determining the removal of the HMD during the period of time. A view of the user representation may be provided based on the user representation data, e.g., showing the current appearance of the user at points in time during the period of time prior to the removal based on current sensor data and then showing an adjusted (e.g., neutral) appearance of the user at points in time during the period of time after removal.

In accordance with some implementations, a non-transitory computer readable storage medium has stored therein instructions that are computer-executable to perform or cause performance of any of the methods described herein. In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein.

### BRIEF DESCRIPTION OF THE DRA WINGS

So that the present disclosure can be understood by those of ordinary skill in the art, a more detailed description may be had by reference to aspects of some illustrative implementations, some of which are shown in the accompanying drawings.

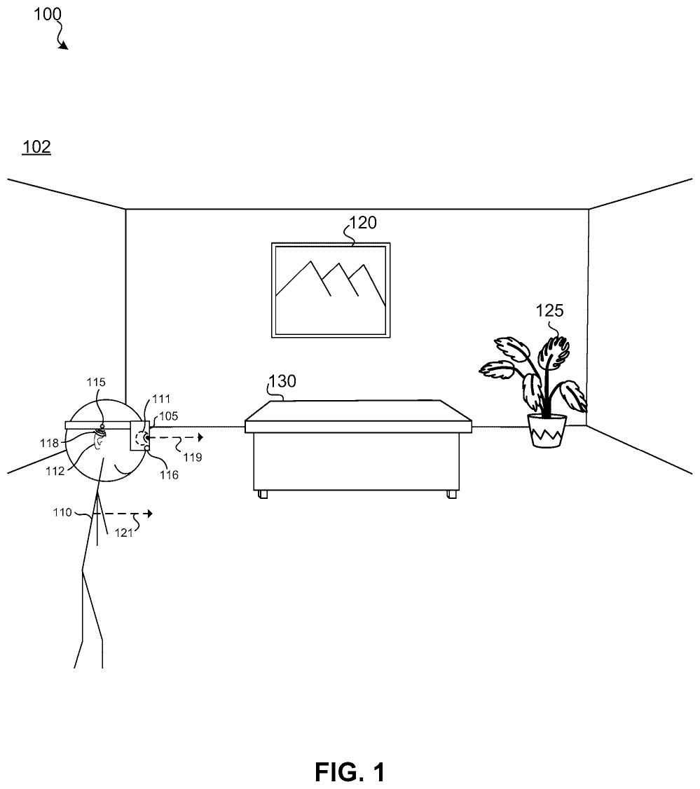

FIG. 1 illustrates a device obtaining sensor data from a user according to some implementations.

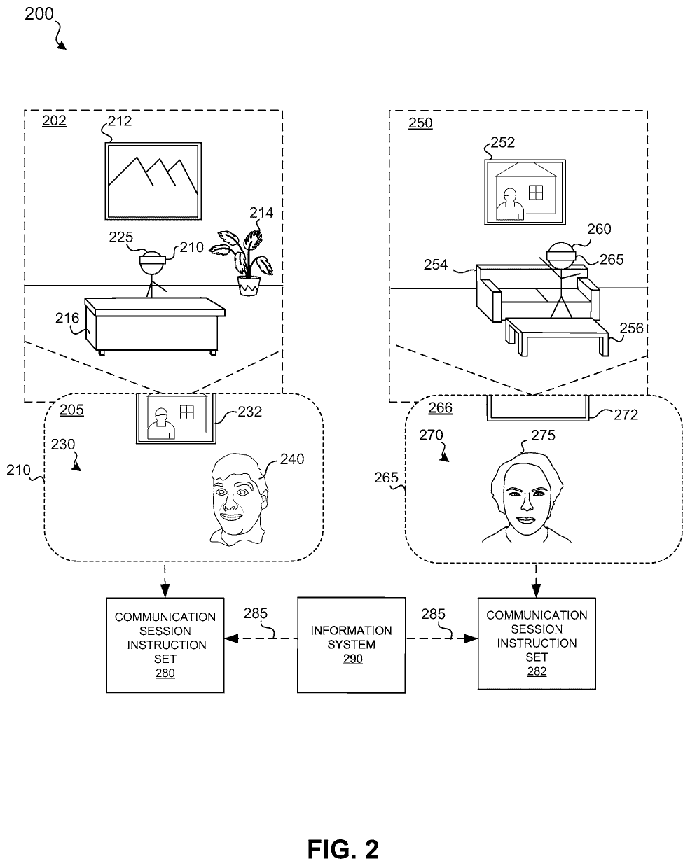

FIG. 2 illustrates exemplary electronic devices operating in different physical environments during a communication session in accordance with some implementations.

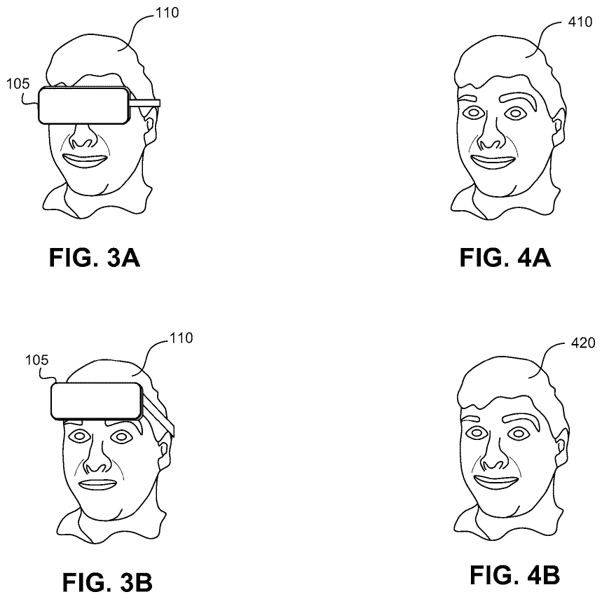

FIGS. 3A-B illustrate a portion of a user's face during exemplary instants in time during a period of time during which a user removes a device, in accordance with some implementations.

FIGS. 4A-B illustrate the representation of the user's face of FIGS. 3A-B generated for the instants in time during the period of time in accordance with some implementations.

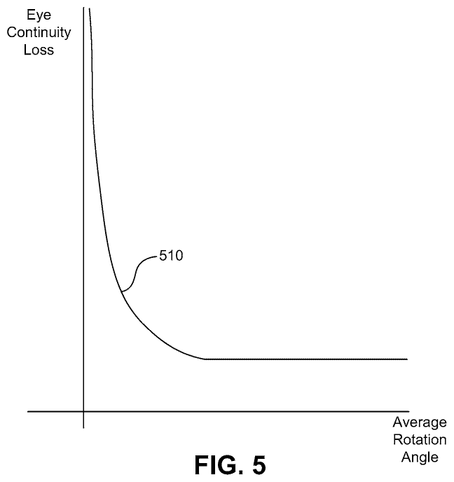

FIG. 5 depicts a chart illustrating curves representing orientation/position change information used in different eye continuity circumstances to determine whether a user is performing a doffing motion, in accordance with some implementations.

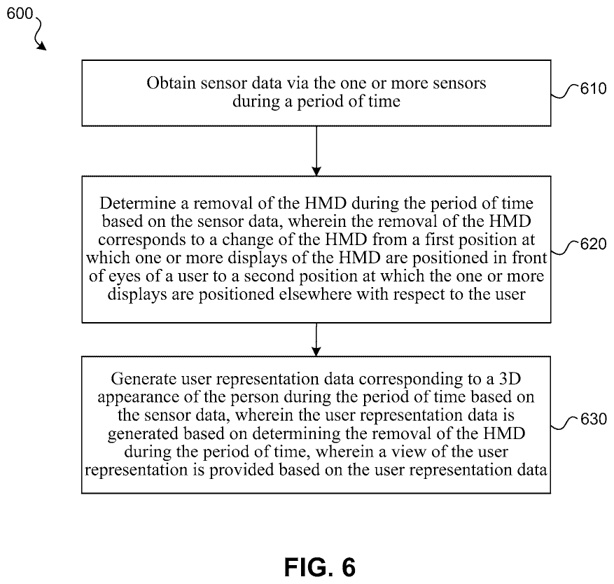

FIG. 6 is a flowchart representation of a method for maintaining user representation appearance during device removal, in accordance with some implementations.

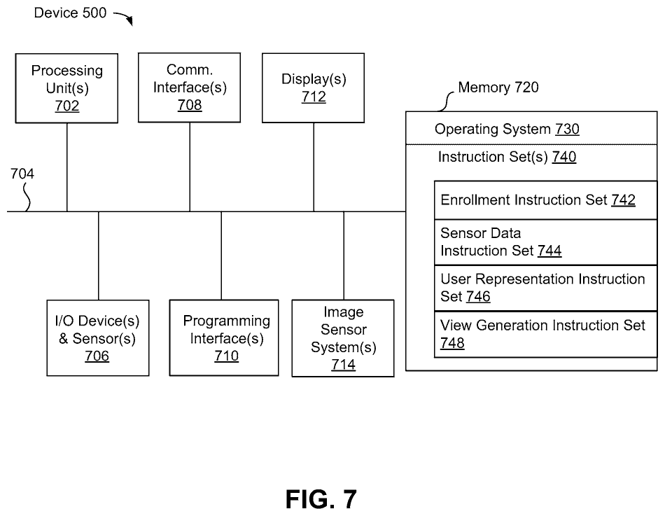

FIG. 7 is a block diagram illustrating device components of an exemplary device according to some implementations.

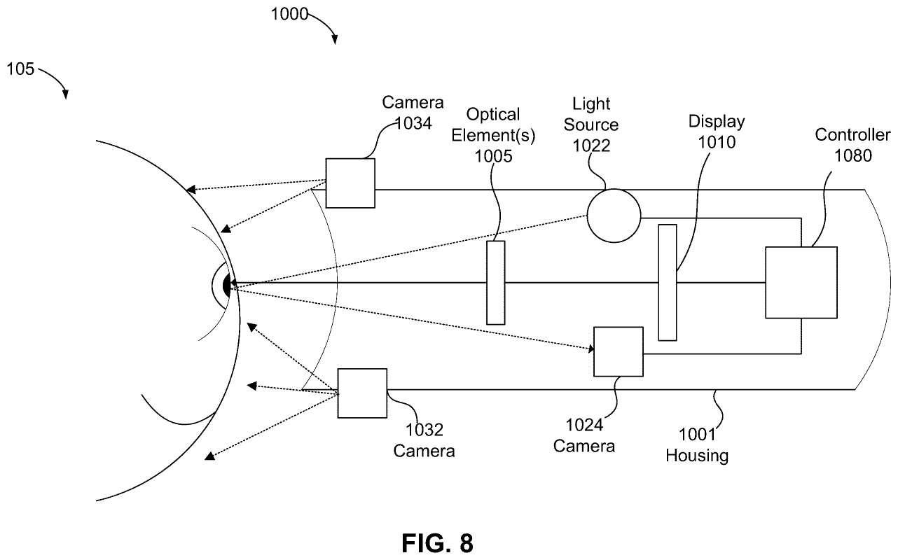

FIG. 8 is a block diagram of an example head-mounted device (HMD) in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects or variants do not include all of the specific details described herein. Moreover, well-known systems, methods, components, devices and circuits have not been described in exhaustive detail so as not to obscure more pertinent aspects of the example implementations described herein.

FIG. 1 illustrates an example environment 100 of exemplary electronic device 105, operating in a physical environment 102. In some implementations, electronic device 105 may be able to share information with another device or with an intermediary device, such as an information system. Additionally, physical environment 102 includes user 110 wearing device 105. In some implementations, the device 105 is configured to present views of an extended reality (XR) environment, which may be based on the physical environment 102, and/or include added content such as virtual elements.

In the example of FIG. 1, the physical environment 102 is a room that includes physical objects such as wall hanging 120, plant 125, and desk 130. The electronic device 105 may include one or more cameras, microphones, depth sensors, motion sensors, or other sensors that can be used to capture information about and evaluate the physical environment 102 and the objects within it, as well as information about user 110.

In the example of FIG. 1, the device 105 includes one or more sensors 116 that capture light-intensity images, depth sensor images, audio data or other information about the user 110 (e.g., internally facing sensors and/or externally facing cameras). For example, the one or more sensors 116 may capture images of the user's (e.g., user 110) forehead, eyebrows, eyes, eye lids, cheeks, nose, lips, chin, face, head, hands, wrists, arms, shoulders, torso, legs, or other body portion. For example, internally facing sensors may see what's inside of the device 105 (e.g., the user's eyes and around the eye area), and other external cameras may capture the user's face outside of the device 105 (e.g., egocentric cameras that point toward the user 110 outside of the device 105). Sensor data about a user's eye 111, as one example, may be indicative of various user characteristics, e.g., the user's gaze direction 119 over time, user saccadic behavior over time, user eye dilation behavior over time, etc. The one or more sensors 116 may capture audio information including the user's speech and other user-made sounds as well as sounds within the physical environment 100.

In some implementations, the device 105 includes an eye tracking system for detecting eye position and eye movements via eye gaze characteristic data. For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user 110. Moreover, an illumination source of the device 105 may emit NIR light to illuminate the eyes of the user 110 and an NIR camera may capture images of the eyes of the user 110. In some implementations, images captured by the eye tracking system may be analyzed to detect position and movements of the eyes of the user 110, or to detect other information about the eyes such as color, shape, state (e.g., wide open, squinting, etc.), pupil dilation, or pupil diameter. Moreover, the point of gaze estimated from the eye tracking images may enable gaze-based interaction with content shown on the near-eye display of the device 105.

Additionally, the one or more sensors 116 may capture images of the physical environment 100 (e.g., externally facing sensors). For example, the one or more sensors 116 may capture images of the physical environment 100 that includes physical objects such as wall hanging 120, plant 125, and desk 130. Moreover, the one or more sensors 116 may capture images (e.g., light intensity images and/or depth data).

One or more sensors, such as one or more sensors 115 on device 105, may identify user information based on proximity or contact with a portion of the user 110. As example, the one or more sensors 115 may capture sensor data that may provide biological information relating to a user's cardiovascular state (e.g., pulse), body temperature, breathing rate, etc.

The one or more sensors 116 or the one or more sensors 115 may capture data from which a user orientation 121 within the physical environment can be determined. In this example, the user orientation 121 corresponds to a direction that a torso of the user 110 is facing.

Some implementations disclosed herein determine a user understanding or a scene understanding based on sensor data obtained by a user worn device, such as first device 105. Such a user understanding may be indicative of a user state that is associated with providing user assistance or facilitating a communication session.

Content may be visible, e.g., displayed on a display of device 105, or audible, e.g., produced as audio 118 by a speaker of device 105. In the case of audio content, the audio 118 may be produced in a manner such that only user 110 is likely to hear the audio 118, e.g., via a speaker proximate the ear 112 of the user or at a volume below a threshold such that nearby persons are unlikely to hear. In some implementations, the audio mode (e.g., volume), is determined based on determining whether other persons are within a threshold distance or based on how close other persons are with respect to the user 110.

In some implementations, the content provided by the device 105 and sensor features of device 105 may be provided using components, sensors, or software modules that are sufficiently small in size and efficient with respect to power consumption and usage to fit and otherwise be used in lightweight, battery-powered, wearable products such as wireless ear buds or other ear-mounted devices or head mounted devices (HMDs) such as smart/augmented reality (AR) glasses. Features can be facilitated using a combination of multiple devices. For example, a smart phone (connected wirelessly and interoperating with wearable device(s)) may provide computational resources, connections to cloud or internet services, location services, etc.

The device 105 may generate user face representations of user 110 based on image and/or other sensor data for various purposes. For example, the user 110 may use the device 105 (e.g., a head-mounted device (HMD)) that has image sensors that capture images of the user's face portions (e.g., images of the user's eyes via cameras inside the HMD and/or images of the user's cheeks, nose, and mouth via downward-facing cameras on the HMD). A stream of image and/or other sensor data may be obtained over time and used to animate a user face representation, e.g., providing a user avatar that represents the user's face as the user forms facial expressions and otherwise moves their face over time.

A user representation may combine live and prior data about the user. For example, live sensor data representing the current appearance of the portions of the user's face (e.g., images of the user's eyes via cameras inside the HMD and/or images of the user's cheeks, nose, and mouth via downward-facing cameras on the HMD) may be combined with prior data representing the face at one or more prior times (e.g., enrollment data representing the face without the HMD on in one or more expressions, e.g., neutral expressions, smiling expressions, etc.).

User face representation data may be 3D or otherwise use information about the 3D appearance of the user's face. In some implementations, current sensor data corresponding to the users' current/live face appearance (e.g., current images from inward and downward facing sensors) is combined with information about the 3D shape of the user's face to provide the user face representation. A user's face representation may be used for numerous purposes including, but not limited to, to provide a representation of the user that is provided to one or more other users during a communication session.

FIG. 2 illustrates exemplary electronic devices operating in different physical environments during a communication session involving a first user at a first device and a second user at a second device with a view of a 3D representation of the second user for the first device. In particular, FIG. 2 illustrates exemplary operating environment 200 of electronic devices 210, 265 operating in different physical environments 202, 250, respectively, during a communication session, e.g., while the electronic devices 210, 265 are sharing information with one another or an intermediary device such as a communication session system/server. In this example of FIG. 2, the physical environment 202 is a room that includes a wall hanging 212, a plant 214, and a desk 216 (e.g., physical environment 102 of FIG. 1). The electronic device 210 includes one or more cameras, microphones, depth sensors, or other sensors that can be used to capture information about and evaluate the physical environment 202 and the objects within it, as well as information about the user 225 of the electronic device 210 (e.g., a handheld device). The information about the physical environment 202 and/or user 225 may be used to provide visual content (e.g., for user representations) and audio content (e.g., for audible voice or text transcription) during the communication session. For example, a communication session may provide views to one or more participants (e.g., users 225, 260) of a 3D environment that is generated based on camera images and/or depth camera images of the physical environment 202, a representation of user 225.

Additionally, in this example of FIG. 2, the physical environment 250 is a room that includes a wall hanging 252, a sofa 254, and a coffee table 256. The electronic device 265 includes one or more cameras, microphones, depth sensors, or other sensors that can be used to capture information about and evaluate the physical environment 250 and the objects within it, as well as information about the user 260 of the electronic device 265 (e.g., a user worn device or HMD device, such as device 105). The information about the physical environment 250 and/or user 260 may be used to provide visual and audio content during the communication session. For example, a communication session may provide views of a 3D environment that is generated based on camera images and/or depth camera images (from electronic device 265) of the physical environment 250 as well as a representation of user 260 based on camera images and/or depth camera images (from electronic device 265) of the user 260. For example, a 3D environment may be sent by the device 210 by a communication session instruction set 280 in communication with the device 265 by a communication session instruction set 282 (e.g., via the information system 290 via network connection 285).

The information system 290 may orchestrate the sharing of assets (e.g., data associated with user representations 240, 275) between two or more devices (e.g., electronic devices 210 and 265).

FIG. 2 illustrates an example of a view 205 provided at device 210, where a representation 232 of the wall hanging 252 and a user representation 240 is provided (e.g., a persona of user 260), provided there is a consent to view the users' representations of each user during a particular communication session. In particular, the user representation 240 of user 260 is generated based on one or more user representation techniques. The generation of user representations is further discussed herein. Additionally, the electronic device 265 within physical environment 250 provides a view 266 that enables user 260 to view representation 272 of the wall hanging 212 and a representation 275 (e.g., a persona) of at least a portion of the user 225 (e.g., from mid-torso up) within the 3D environment 270. The user representation 240 of user 260 may be generated at device 210 (e.g., the receiving/viewing device) by generating representations of the user 260 for the multiple instants in a period of time based on data obtained from device 265 (e.g., a frame-specific 3D representation of user 260). Alternatively, in some embodiments, user representation 240 of user 260 is generated at device 265 (e.g., the sending device) and sent to device 210 (e.g., receiving/viewing device to view a persona of the sender). In some embodiments, each of the 3D representations 240 of user 260 and 275 of user 225 is generated by generating splats corresponding to user representation data.

In the example of FIG. 2, the electronic devices 210, 265 are illustrated as a head-mounted devices (HMDs). However, either of the electronic devices 210, 265 may be a mobile phone, a tablet, a laptop, or any other form of wearable device (e.g., head-worn device (glasses), headphones, an ear mounted device, and so forth). In some implementations, functions of each of the devices 210 and 265 are accomplished via two or more devices, for example a mobile device and base station or a head-mounted device and an ear mounted device. Various capabilities may be distributed amongst multiple devices, including, but not limited to power capabilities, CPU capabilities, GPU capabilities, storage capabilities, memory capabilities, visual content display capabilities, audio content production capabilities, and the like. The multiple devices that may be used to accomplish the functions of electronic devices 210 and 265 may communicate with one another via wired or wireless communications. In some implementations, each device communicates with a separate controller or server to manage and coordinate an experience for the user (e.g., a communication session server). Such a controller or server may be located within or may be remote relative to the physical environment 202 and/or physical environment 250.

Additionally, in the example of FIG. 2, the 3D environments 230 and 270 may be based on a common coordinate system that can be shared with other users (e.g., providing a virtual room for personas for a multi-person communication session). In other words, a common coordinate system may be used for the 3D environments 230 and 270. A common reference point may be used to align the coordinate systems. In some implementations, the common reference point may be a virtual object within the 3D environment that each user can visualize within their respective views. For example, a common center piece table that the user representations (e.g., the user's personas) are positioned around within the 3D environment. Alternatively, the common reference point is not visible within each view. For example, a common coordinate system of a 3D environment may use a common reference point for positioning each respective user representation (e.g., around a table/desk). Thus, if the common reference point is visible, then each view of the device would be able to visualize the “center” of the 3D environment for perspective when viewing other user representations. The visualization of the common reference point may become more relevant with a multi-user communication session such that each user's view can add perspective to the location of each other user during the communication session.

In some implementations, the representations of each user may be realistic or unrealistic and/or may represent a current and/or prior appearance of a user. For example, a photorealistic representation of the user 225 or 260 may be generated based on a combination of live images and prior images of the user. The prior images may be used to generate portions of the representation for which live image data is not available (e.g., portions of a user's face that are not in view of a camera or sensor of the electronic device 210 or 265 or that may be obscured). In one example, the electronic devices 210 and 265 are HMDs and live image data of the user's face includes a downward facing camera that obtains images of the user's cheeks and mouth and inward facing camera images of the user's eyes, which may be combined with prior image data of the user's other portions of the user's face, head, and torso that cannot be currently observed from the sensors of the device. Prior data regarding a user's appearance may be obtained at an earlier time during the communication session, during a prior use of the electronic device, during an enrollment process used to obtain sensor data of the user's appearance from multiple perspectives and/or conditions, or otherwise.

In some implementations, generating views of one or more user representations for a communication session as illustrated in FIG. 2 (e.g., generating user representation 240, 275), may be based on one more rendering techniques, such as using a 3D mesh, 3D point cloud, or a 3D gaussian splat rendering approach. Such a 3D gaussian splat rendering approach may use UV mapping and generate a proxy mesh representation.

Some implementations disclosed herein relate to maintaining user representation appearance during device removal, e.g., when an HMD is doffed or taken off. As illustrated in FIG. 2, in multi-user XR environments, device users may view representations of one another that are based on their respective actual appearances. For example, an avatar used by a user may be based on prior and/or current image and/or other sensor data captured regarding the user's appearance. In one example, a user's avatar is based on a combination of images of the user captured before and during an shared XR session, e.g., based on images of the user's entire face (i.e., without wearing an HMD) captured during an enrollment period or otherwise prior to the XR session and images of portions of the user's face captured during the session (e.g., via internal cameras capturing the current/live appearance of the user's eye region, downward camera's capturing the current/live appearance of the user's cheeks, mouth, outward facing camera's capturing the current/live appearance of the user's hands, etc.).

Existing devices and methods may not adequately account for a user removing (e.g., doffing of taking off) a wearable device (e.g., HMD) during user representation generation, e.g., while using an avatar during a multi-user XR session. Existing systems may not adequately recognize circumstances in which the appearance of user's avatar should be altered to account for removal (e.g., doffing by raising an HMD off of the eye region to rest on the forehead or completely removing the HMD from the head) and/or may not alter the appearance of the user's avatar in such scenarios in a desirable way.

Some implementations disclosed herein utilize sensor data to recognize circumstances in which the appearance of a user representation (e.g., avatar) should be altered to account for HMD removal (e.g., doffing or taking off). For example, this may involve using motion sensor data to detect device changes in position and/or orientation and/or eye-sensor data to determine when the user's eye (whether open or closed) is present within the eye box region of the device. Some implementations alter the appearance of the user's avatar in such scenarios in a desirable way, for example, by freezing the current appearance and/or position of the user's avatar (e.g., the head of the avatar) and/or displaying a fixed avatar appearance (e.g., displaying a neutral avatar appearance based on a pre-session/enrollment neutral avatar appearance).

FIGS. 3A-B illustrate a portion of a user's face during exemplary instants in time during a period of time during which a user removes a device (e.g., doffs the HMD in this example). During this period of time, a representation of the user's face is to be generated based on the sensor data. At a first instant in time (shown in FIG. 3A) the user is wearing device 105 in its normal use position (relative to the user's face) and the user's face is accessible to be captured via one or more sensors (e.g., via one or more outward/downward facing sensors on device 105). Following the first instant in time, at a second instant in time (shown in FIG. 3B), the user has moved the device 105 from its initial normal use position to another, different position (resting on the user's forehead rather than in the normal use position in front of the user's eyes). In this second position, the view from the one or more sensors (e.g., one or more outward/downward facing sensors on device 105) would not capture the appropriate portions of the user's face for use in generating a user representation or would capture images from an unexpected viewpoint of the user's face. If such sensor data were used to continue generating the current appearance of the user representation, such an appearance may appear distorted or otherwise undesirable.

The sensor data may reflect an unintended movement of the user's face as the device transitions between its positions depicted in FIGS. 3A to 3B (e.g., the eyes moving/sliding down at the beginning of doffing). In this situation, the device 105 may interpret the doffing movement as actual head movement and cause a corresponding movement of the representation. The device 105 may be configured to quickly detect and promptly preempt such unintended consequences from such movements/changes. For example, a detection process used by the device 105 may be configured to detect slight/small scale movements and/or responds quickly when such movements are initiated/first started, such that the device 105 is able to promptly and accurately detect their occurrences and perform the mitigation techniques discussed herein. For instance, any simultaneous movement of the user's eyes sensed by the sensors that is abnormal may be promptly detected and an appropriate mitigation immediately performed.

FIGS. 4A-B illustrate the representation of the user's face of FIGS. 3A-B generated for the instants in time during the period of time. Specifically, for the first instant in time (illustrated in FIG. 3A), a user representation 410 (illustrated in FIG. 4A) is generated based on live sensor data capturing sensor data (e.g., captured via one or more outward/downward facing sensors on device 105) of the user's face. The user representation 410 depicts a live/current appearance of the user's face since sensor data from normal expected positions relative to the user's face is obtainable at this first instant in time. The user representation 410 may provide such an appearance using only live sensor data or a combination of live and previously captured sensor data (e.g., data form a prior user enrollment). It shows the user's live/current appearance (e.g., if the user is currently smiling, user representation 410 will depict the user's mouth region as smiling, etc.). In this example user representation 410, an appearance of the face is depicted based on a combination of current sensor data (e.g., internal facing cameras capturing the live/current condition of the user's eye region and downward facing image cameras capturing the live/current appearance of the user's lower face) and prior enrollment data (e.g., information such as color about the appearance of the user's eyes captured in sensor data when the device was not being worn by the user, information about portions of the user's face occluded by the wearing of the HMD, etc.).

For the second instant in time (illustrated in FIG. 3B), the user representation 420 (illustrated in FIG. 4B) depicts a non-live/non-current appearance of at least a portion of the user's face since such portion of the face is not adequately captured in sensor data at this second instant in time (e.g., the camera's changed positions relative to the user's face does not provide appropriate views of the user's face for purposes of generating an accurate user representation). Instead, information about a prior appearance of the user's face is used. The user representation 420 depicted in FIG. 4B maintains its appearance from the user representation 410 depicted in FIG. 4A. In this example, user representation 420 is generated based on sensor data captured at the first instant in time (corresponding to FIG. 3A) when the appropriate sensor data was available due the sensors being in normal use positions relative to the user at that instant in time, e.g., the user representation may maintain its appearance from the prior first instant in time during the second instant in time. In this example user representation 420, an eye region of the face is depicted based on a combination of sensor data from the first instant in time (e.g., internal facing cameras capturing the user appearance of FIG. 3A) and prior enrollment data (e.g., information such as color about the appearance of the user's eyes captured in sensor data when the device was not being worn by the user). Thus, the user representation may combine information from a user enrollment (e.g., information about user eye color) with other prior information about the user's face from a recent instant in time (e.g., information about a user's lower face portion and/or eyes that is currently not available in current/live sensor data, but that is available from recently obtained sensor data at the prior, recent instant in time, e.g., at the first instant in time of FIG. 3A).

Some implementations utilize one or more algorithms or machine learning (ML) models to maintain the robustness of a user's avatar when the user removes an HMD (e.g., raises it to their forehead or removes it completely). During such removal, the appearance of the avatar may otherwise be deformed or otherwise be changed in an unnatural/undesirable way, e.g., based on the images of the user's eyes and/or other face portions not being captured from expected capture positions as the device is removed (e.g., doffed or completely removed).

Some implementations determine that removal (e.g., doffing or taking off) is occurring using sensor data corresponding to the user's eyes. The HMD device may be configured to track the user's eye for one or more other purposes (e.g., for gaze-based input, user recognition, to determine when the device is in use, to lock the device in certain circumstances, etc.) via one or more other systems. Some implementations determine/track whether the user's eyes are visible or not. Some implementations may determine/track/distinguish between when a user's eye is not visible because the eyelid is closed and when the user's eye is not visible because the headset is being removed and thus the eye is no longer in its expected position relative to the device. In some implementations, the HMD may detect unexpected movement, such as any simultaneous movement of the eyes in a downward direction (as may occur for example when the device is moved upward relative to the user's face). The system may track eye-information in a way that distinguishes between the user's eye being closed and the user's closed eye not being present or moving in an unexpected manner, such that the system can determine that the user's eye is present or not present in/abnormal from an expected position (e.g., in a normal use position relative to the HMD) regardless of whether the eye is open or closed. Such information may be used to determine that removal (e.g., doffing of taking off) is occurring. In some implementations, timely detection of device removal is facilitated by detecting abnormal positioning of one or both eyes relative to the devices as soon as such abnormal positioning occurs. It may detect right when the user is starting to move the device (e.g., moving the device upward) from its normal position (e.g., its position depicted in FIG. 3A) and promptly perform mitigation accordingly.

In one example, a triggering event (e.g., detecting that the eye is not visible to an eye image sensor), triggers use of an eye tracking continuity system. It may trigger the use of such an eye continuity tracking system at a higher-than-normal frequency (e.g., 30-45 hertz) to efficiently and promptly detect when the user is lifting the device up relative to their face, e.g., lifting to the forehead or off of the head. Triggering eye continuity in only certain circumstances at which removal (e.g., doffing or taking off) may be beginning may improve the system's efficiency, responsiveness, and/or accuracy.

In some implementations, an eye tracking continuity system that is used for another purpose is additionally used for removal (e.g., doffing of taking off) detection. In other implementations, information (e.g., about eye continuity) is not available via another system and the device uses an eye continuity system specifically (e.g., only) to detect removal (e.g., doffing or taking off).

In some implementations, information from other sensors or systems is additionally, or alternatively, used to identify removal (e.g., doffing or taking off). As examples, motion sensor data may be used to detect HMD orientation and/or positional changes that are compared against one or more thresholds to detect removal. In some implementations, three input signals (e.g., orientation change, position change, and eye continuity loss) are used.

In some implementations input signals (e.g., regarding orientation change, position change, and eye continuity loss) are assessed relative to a curve to identify that removal (e.g., doffing or taking off) is occurring. FIG. 5 depicts a chart illustrating curves representing orientation/position change information used in different eye continuity circumstances to determine whether a user is performing a doffing motion, in accordance with some implementations. One or more thresholds may be used to determine when a device has been removed. For example, a device removal event may be identified if/when the device's position changes more than threshold A. As another example, after eye continuity is lost, a device removal event may be identified if/when the device's orientation changes more than threshold B identify.

How input signal information is used to identify device removal events (e.g., the associated thresholds(s) for orientation change and/or position changed used to identify a removal) may depend upon how long (e.g., how many frames) eye continuity data has been lost. For example, one or more curves may be used to specify how orientation information (e.g., from a gyroscope) and/or position change information (e.g., from an accelerometer) will be used in different eye continuity circumstances (e.g., shorter or longer period) to determine whether a user is performing a doffing motion or not. The curve 510 illustrated in FIG. 5 is an example. In this FIG. 5, the x axis represents average rotation angle, e.g., average of 3 past rotation angles of the device and the y axis represents eye continuity data, e.g., the number of frames/time period during which the eye (or both eyes) is not detected in its expected location. Such a curve 510 is based on the expectation that, if there is going to be greater/faster doffing motion (e.g., large quick orientation or positional changes), then less eye continuity (e.g., fewer frames during which the eye is not found at its expected location) is required to determine that doffing is occurring. Using such threshold adjustments/curves can protect against false negatives, e.g., detecting doffing when the user is just adjusting an HMD on their face, while ensuring that doffing is detected quickly in circumstances in which the user is quickly doffing the HMD. Note that eye movements of both eyes may be considered to determine whether doffing or other removal is occurring, e.g., to distinguish between the device being moved upward and off of the user's eye region from the device being tilted to be crooked or temporarily skewed, but still generally in front of the user's eyes.

A gyroscope may be used to provide orientation (e.g., roll, pitch, yaw) information, e.g., to detect changes in orientation greater than a threshold. An accelerometer may be used to provide position, velocity, and/or acceleration changes in 3D space, e.g., relative one or more particular axis, such as the y axis, e.g., to detect changes in position, velocity, and/or acceleration relative to one or more thresholds.

In some implementations, information about both eyes (e.g., stereo) is used to detect removal (e.g., doffing or taking off).

Once removal is detected, some implementations alter the appearance of the user's avatar in a desirable way. In some implementations, this involves using the avatar's position and/or appearance from a prior instant before the removal begins (e.g., using the avatar state from 5 frames ago, 150 ms ago, etc.). In some implementations this involves “freezing” the current position/skeleton of the user representation (e.g., the head of an avatar) and/or displaying a fixed user representation appearance (e.g., displaying a neutral avatar appearance based on a pre-session/enrollment neutral avatar appearance). This may provide a naturally-appearing face while also indicating to other user who may be viewing the avatar that the user associated with the user representation has doffed or is not wearing the HMD.

Once the user repositions the device in front of their open eye(s) (e.g., moving the device from a removed to position to a normal use position), the eye tracking system on the device may detect the open eye(s) in their expected position and this may trigger the end of the altered user representation appearance, e.g., the avatar's appearance may again be based on the user's current/live appearance.

Some implementations utilize information from a prior user enrollment in providing current/live or non-current/non-live user representation appearances. During such an enrollment, the system (e.g., HMD) may have captured images or other sensor data corresponding to the user's face in one or more particular (e.g., smiling, frowning, neutral, mouth-closed, expressionless, etc.) configurations. Such information may be used for later periods during which a user representation requires current, last-captured, or otherwise recent user sensor data. Recently-captured sensor information may be preserved (e.g., stored in memory for a limited period of time) for use in generating such user representations, e.g., saving the camera or other sensor data from one or more instants in time during and prior to the current instant in time.

In circumstances in which a user representation does not correspond to the user's current appearance (e.g., when it is configured to account for the device having been removed), one or more effects may be applied to provide a better viewing experience. For example, a treatment (e.g., blurring, feathering, etc.) may be applied indicate to the viewer that the user representation does not necessarily correspond to the user's current appearance. In some implementations, changes to a user representation when a device is removed are implemented gradually, e.g., changing the user representation to a neutral expression gradually over a relatively short time period. This may convey to an observer that the user's face is not frozen/stuck in the prior position and/or avoid continuing to display a representation in an unnatural or otherwise undesirable frozen pose (e.g., appearing to be frozen with mouth wide open, etc.). In some examples, this involves gradually (e.g., over a period of time) morphing or fading the appearance of the obscured portion of the user's face to a different expression, e.g., to a neutral/expressionless or other predetermined expression). For example, the user's face may initially be displayed in its prior pose and then gradually be morphed/faded back to a neutral mouth expression using enrollment data. This may help ensure that if the user is doing something unusual with their mouth, the user is not just stuck with that unusual (e.g., funny/frozen-looking) mouth expression for a long time after the device is removed.

Once the device is returned to its normal use position, the device (e.g., HMD) may blend from the predetermined (e.g., neutral) expression back to a live animated view, e.g., using live sensor data of the user's face. In alternative implementations, once the device is returned to its normal use position, e.g., in the case of a short-lived removal of the device, the device blends from the prior-expression-based representation (or from the current blend of prior-expression and predetermined expression) back to the live animated view.

In some implementations, one or more visual treatments are applied during the period of time during which a portion of a user's face is not based on live, current sensor data, e.g., during the time during which the device is removed (e.g., doffed or taken off). Such treatment may blur, add (e.g., adding a light blue glow), or otherwise modify the appearance. Additionally (or alternatively), such visual treatments may convey to an observer that what the observer is seeing may not be the user's actual mouth, e.g., that it may not depict the user's actual current facial expression. The visual effect may convey uncertainty or another measure of inaccuracy. The amount or other attributes of the visual effect may depend upon the amount of time that has passed since the device was removed, e.g. increasing the amount and/or size of blur and/or glow effect based on the amount of the time that has passed.

In some implementations, the device (e.g., HMD) is configured to predict that a device is about to be removed, e.g., based on a contextual understanding of what the user is doing, the user's hands being positioned on the sides of the device, and understanding of what the user is saying (e.g., the user saying “I am taking my device off for a minute”, etc.), and/or other contextual information about the user, other users, or the environment. A visual treatment may be applied based on the prediction. In some implementations, during a period before a device is removed, the device obtains information that will be use once the device is removed (e.g., additional current/live sensor data, previously generated neutral expression data, etc.)

In some implementations, a representation of a user's face includes or is otherwise based on Gaussian splats, e.g., via a Gaussian spat-based 3D representation. In such implementations, facial expression blending over time may account for the splat-based representation. Blending based on splats may look very realistic and thus undesirably convey to an observer that the user's face has an expression that is not the user's real, current expression. Accordingly, visual treatments or other processes may be performed to intentionally convey that a user's face may have a different expression. For example, rather than smoothly blending between a user's previous facial expression to a predetermined/neutral expression, the transition may be intentionally speckled, modified with a classic-film dissolve effect, in a way that feels “smooth” but not like a natural human motion. For example, a film cross-dissolve effect is smooth, but an external viewer can easily tell it's an artificial transition effect, rather than the user actual closing their mouth.

FIG. 6 is a flowchart illustrating an exemplary method 600. In some implementations, a device (e.g., device 105 of FIG. 1) performs the techniques of method 600 for maintaining user representation appearance during device removal. In some implementations, the techniques of method 600 are performed on a mobile device, desktop, laptop, HMD, or server device. In some implementations, the method 600 is performed on processing logic, including hardware, firmware, software, or a combination thereof. In some implementations, the method 600 is performed on a processor executing code stored in a non-transitory computer-readable medium (e.g., a memory). In some implementations, the method 600 is implemented at a processor of a device, such as a viewing device, that renders a representation of a user (e.g., device 210 of FIG. 2 renders 3D representation 240 of user 260 from data obtained from device 265).

At block 610, the method 600 involves obtaining sensor data via the one or more sensors during a period of time. Such sensor data may include images, depth sensor data, or any other sensor data corresponding to the appearance of the user at a prior (e.g., at enrollment, during a prior session, during a current session) and/or current point in time.

At block 620, the method 600 involves determining a removal (e.g., doffing or taking off) of the HMD during the period of time based on the sensor data, wherein the removal of the HMD corresponds to a change of the HMD from a first position at which one or more displays of the HMD are positioned in front of eyes of a user to a second position at which the one or more displays are positioned elsewhere with respect to the user. Determining removal of the HMD may comprise determining that the HMD is being doffed. Determining removal of the HMD may comprise determining a change of user eye position relative to an eye box region of the device. Determining removal may involve determining that the device's position changes from its normal use position in front of the user's eyes to a removed (doffed or taken off) position. Determining removal may be based on detecting that an eye is no longer present within an eye box region of the device (e.g., based on eye sensor data) and that the device has changed position more than a threshold amount or changed orientation more than a threshold amount.

At block 630, the method 600 involves generating user representation data corresponding to a 3D appearance of the person during the period of time based on the sensor data, wherein the user representation data is generated based on determining the removal of the HMD during the period of time, wherein a view of the user representation is provided based on the user representation data. The view of the user representation may be presented to another user, for example, during a live communication session with that other user.

Generating the user representation data based on determining the removal of the HMD during the period of time may involve generating the user representation data using current user data prior to the removal and generating the representation data without using current user data after the removal.

After the removal, the user representation data may be configured to represent a neutral appearance of user. After the removal, the user representation data may be configured to represent a prior appearance of user. After the removal, the user representation data may be configured to represent a fixed appearance of the user, e.g., a fixed appearance corresponding to a most recent appearance of the user prior to the removal. After the removal, the user representation data may be configured to represent a fixed appearance of the user corresponding to an appearance of the user prior to the period of time (e.g., displaying a neutral avatar appearance based on a pre-session/enrollment neutral avatar appearance).

Generating the user representation data based on determining the removal of the HMD during the period of time may involve providing a gradual change in the user representation data from representing a current user appearance prior to the removal to representing a fixed user appearance after the removal.

The method 600 may further involve providing a visual treatment for the user representation indicating that the appearance of the user representation after the removal may not depict an actual current appearance of the user.

FIG. 7 is a block diagram of an example device 700. Device 700 illustrates an exemplary device configuration for devices described herein (e.g., devices 105, 210, 265, 410, etc.). While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 700 includes one or more processing units 702 (e.g., microprocessors, ASICs, FPGAs, GPUs, CPUs, processing cores, and/or the like), one or more input/output (I/O) devices and sensors 706, one or more communication interfaces 708 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 710, one or more displays 712, one or more interior and/or exterior facing image sensor systems 714, a memory 720, and one or more communication buses 704 for interconnecting these and various other components.

In some implementations, the one or more communication buses 704 include circuitry that interconnects and controls communications between system components. In some implementations, the one or more I/O devices and sensors 706 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more displays 712 are configured to present a view of a physical environment or a graphical environment to the user. In some implementations, the one or more displays 712 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 712 correspond to diffractive, reflective, polarized, holographic, etc. waveguide displays. In one example, the device 10 includes a single display. In another example, the device 10 includes a display for each eye of the user.

In some implementations, the one or more image sensor systems 714 are configured to obtain image data that corresponds to at least a portion of the physical environment 102. For example, the one or more image sensor systems 714 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 714 further include illumination sources that emit light, such as a flash. In various implementations, the one or more image sensor systems 714 further include an on-camera image signal processor (ISP) configured to execute a plurality of processing operations on the image data.

The memory 720 includes high-speed random-access memory, such as DRAM, SRAM, DDR RAM, or other random-access solid-state memory devices. In some implementations, the memory 720 includes non-volatile memory, such as one or more magnetic disk storage devices, optical disk storage devices, flash memory devices, or other non-volatile solid-state storage devices. The memory 720 optionally includes one or more storage devices remotely located from the one or more processing units 702. The memory 720 includes a non-transitory computer readable storage medium.

In some implementations, the memory 720 or the non-transitory computer readable storage medium of the memory 720 stores an optional operating system 730 and one or more instruction set(s) 740. The operating system 730 includes procedures for handling various basic system services and for performing hardware dependent tasks. In some implementations, the instruction set(s) 740 include executable software defined by binary information stored in the form of electrical charge. In some implementations, the instruction set(s) 740 are software that is executable by the one or more processing units 702 to carry out one or more of the techniques described herein.

The instruction set(s) 740 include an enrollment instruction set 742, a sensor data instruction set 744, a user representation instruction set 746, and a view generation instruction set 748. The instruction set(s) 740 may be embodied a single software executable or multiple software executables.

In some implementations, the enrollment instruction set 742 is executable by the processing unit(s) 702 to generate enrollment data from image or other sensor data. The enrollment instruction set 742 may be configured to provide instructions to the user in order to acquire image or other sensor information to generate the enrollment data and determine whether additional information is needed. To these ends, in various implementations, the instruction includes instructions and/or logic therefor, and heuristics and metadata therefor.

In some implementations, the sensor data instruction set 744 is executable by the processing unit(s) 702 to obtain sensor data, as described herein. To these ends, in various implementations, the instruction includes instructions and/or logic therefor, and heuristics and metadata therefor.

In some implementations, the user representation instruction set 746 is executable by the processing unit(s) 702 to generate and/or modify a user representation (e.g., user representation data) using one or more of the techniques discussed herein or as otherwise may be appropriate. To these ends, in various implementations, the instruction includes instructions and/or logic therefor, and heuristics and metadata therefor.

In some implementations, the view generation instruction set 748 is executable by the processing unit(s) 702 to perform shading and/or rendering to provide a view of a user representation using one or more of the techniques discussed herein or as otherwise may be appropriate. To these ends, in various implementations, the instruction includes instructions and/or logic therefor, and heuristics and metadata therefor.

Although the instruction set(s) 740 are shown as residing on a single device, it should be understood that in other implementations, any combination of the elements may be located in separate computing devices. Moreover, FIG. 7 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

FIG. 8 illustrates a block diagram of an exemplary head-mounted device 1000 in accordance with some implementations. The head-mounted device 1000 includes a housing 1001 (or enclosure) that houses various components of the head-mounted device 1000. The housing 1001 includes (or is coupled to) an eye pad (not shown) disposed at a proximal (to the user 105) end of the housing 1001. In various implementations, the eye pad is a plastic or rubber piece that comfortably and snugly keeps the head-mounted device 1000 in the proper position on the face of the user 105 (e.g., surrounding the eye of the user 105).

The housing 1001 houses a display 1010 that displays an image, emitting light towards or onto the eye of a user 105. In various implementations, the display 1010 emits the light through an eyepiece having one or more optical elements 1005 that refracts the light emitted by the display 1010, making the display appear to the user 105 to be at a virtual distance farther than the actual distance from the eye to the display 1010. For example, optical element(s) 1005 may include one or more lenses, a waveguide, other diffraction optical elements (DOE), and the like. For the user 105 to be able to focus on the display 1010, in various implementations, the virtual distance is at least greater than a minimum focal distance of the eye (e.g., 7 cm). Further, in order to provide a better user experience, in various implementations, the virtual distance is greater than 1 meter.

The housing 1001 also houses a tracking system including one or more light sources 1022, camera 1024, camera 1032, camera 1034, and a controller 1080. The one or more light sources 1022 emit light onto the eye of the user 105 that reflects as a light pattern (e.g., a circle of glints) that can be detected by the camera 1024. Based on the light pattern, the controller 1080 can determine an eye tracking characteristic of the user 105. For example, the controller 1080 can determine a gaze direction and/or a blinking state (eyes open or eyes closed) of the user 105. As another example, the controller 1080 can determine a pupil center, a pupil size, or a point of regard. Thus, in various implementations, the light is emitted by the one or more light sources 1022, reflects off the eye of the user 105, and is detected by the camera 1024. In various implementations, the light from the eye of the user 105 is reflected off a hot mirror or passed through an eyepiece before reaching the camera 1024.

The display 1010 emits light in a first wavelength range and the one or more light sources 1022 emit light in a second wavelength range. Similarly, the camera 1024 detects light in the second wavelength range. In various implementations, the first wavelength range is a visible wavelength range (e.g., a wavelength range within the visible spectrum of approximately 400-700 nm) and the second wavelength range is a near-infrared wavelength range (e.g., a wavelength range within the near-infrared spectrum of approximately 700-1400 nm).

In various implementations, eye tracking (or, in particular, a determined gaze direction) is used to enable user interaction (e.g., the user 105 selects an option on the display 1010 by looking at it), provide foveated rendering (e.g., present a higher resolution in an area of the display 1010 the user 105 is looking at and a lower resolution elsewhere on the display 1010), or correct distortions (e.g., for images to be provided on the display 1010). In various implementations, the one or more light sources 1022 emit light towards the eye 35 of the user 105 which reflects in the form of a plurality of glints.

In various implementations, the camera 1024 is a frame/shutter-based camera that, at a particular point in time or multiple points in time at a frame rate, generates an image of the eye 35 of the user 105. Each image includes a matrix of pixel values corresponding to pixels of the image which correspond to locations of a matrix of light sensors of the camera. In implementations, each image is used to measure or track pupil dilation by measuring a change of the pixel intensities associated with one or both of a user's pupils.

In various implementations, the camera 1024 is an event camera including a plurality of light sensors (e.g., a matrix of light sensors) at a plurality of respective locations that, in response to a particular light sensor detecting a change in intensity of light, generates an event message indicating a particular location of the particular light sensor.

In various implementations, the camera 1032 and camera 1034 are frame/shutter-based cameras that, at a particular point in time or multiple points in time at a frame rate, can generate an image of the face of the user 105. For example, camera 1032 captures images of the user's face below the eyes, and camera 1034 captures images of the user's face above the eyes. The images captured by camera 1032 and camera 1034 may include light intensity images (e.g., RGB) and/or depth image data (e.g., Time-of-Flight, infrared, etc.).

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of physiological data to improve a user's experience of an electronic device with respect to interacting with electronic content. The present disclosure contemplates that in some instances, this gathered data may include personal information data that uniquely identifies a specific person or can be used to identify interests, traits, or tendencies of a specific person. Such personal information data can include physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve interaction and control capabilities of an electronic device. Accordingly, use of such personal information data enables calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access his or her stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs.

Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various objects, these objects should not be limited by these terms. These terms are only used to distinguish one object from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “or” as used herein refers to and encompasses any and all possible combinations of one or more of the associated listed items. It will be further understood that the terms “comprises” or “comprising,” when used in this specification, specify the presence of stated features, integers, steps, operations, objects, or components, but do not preclude the presence or addition of one or more other features, integers, steps, operations, objects, components, or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws.

It is to be understood that the implementations shown and described herein are only illustrative of the principles of the present invention and that various modification may be implemented by those skilled in the art without departing from the scope and spirit of the invention.

What is claimed is:

1. A method comprising:
at a processor of a head-mounted device (HMD) and one or more sensors:
obtaining sensor data via the one or more sensors during a period of time;
determining a removal of the HMD during the period of time based on the sensor data, wherein the removal of the HMD corresponds to a change of the HMD from a first position at which one or more displays of the HMD are positioned in front of eyes of a user to a second position at which the one or more displays are positioned elsewhere with respect to the user; and
generating user representation data corresponding to a three-dimensional (3D) appearance of the person during the period of time, wherein the user representation data is generated based on determining the removal of the HMD during the period of time, wherein a view of the user representation is provided based on the user representation data.

2. The method of claim 1, wherein determining removal of the HMD comprises determining that the HMD is being doffed.

3. The method of claim 1, wherein determining removal of the HMD comprises detecting a change in position or orientation of the HMD based on motion sensor data.

4. The method of claim 1, wherein determining removal of the HMD comprises determining a change of user eye position relative to an eye box region of the device.

5. The method of claim 1, wherein determining removal of the HMD comprises detecting that an eye of the user is no longer within an eye box region of the HMD based on eye sensor data.

6. The method of claim 1, wherein generating the user representation data based on determining the removal of the HMD during the period of time comprises:
generating the user representation data using current user data prior to the removal; and
generating the representation data without using current user data after the removal.

7. The method of claim 1, wherein after the removal, the user representation data represents a neutral appearance of user.

8. The method of claim 1, wherein after the removal, the user representation data represents a prior appearance of user.

9. The method of claim 1, wherein after the removal the user representation data represents a fixed appearance of the user corresponding to a most recent appearance of the user prior to the removal.

10. The method of claim 1, wherein after the removal the user representation data represents a fixed appearance of the user corresponding to an appearance of the user prior to the period of time.

11. The method of claim 1, wherein generating the user representation data based on determining the removal of the HMD during the period of time comprises:
providing a gradual change in the user representation data from representing a current user appearance prior to the removal to representing a fixed user appearance after the removal.

12. The method of claim 1 further comprising providing a visual treatment for the user representation indicating that the appearance of the user representation after the removal may not depict an actual current appearance of the user.

13. The method of claim 1, wherein the view of the user representation is presented to another user during a live communication session.

14. A head mounted device (HMD) comprising:
a non-transitory computer-readable storage medium;
one or more sensors; and
one or more processors coupled to the non-transitory computer-readable storage medium, wherein the non-transitory computer-readable storage medium comprises program instructions that, when executed on the one or more processors, cause the one or more processors to perform operations comprising:
obtaining sensor data via the one or more sensors during a period of time;
determining a removal of the HMD during the period of time based on the sensor data, wherein the removal of the HMD corresponds to a change of the HMD from a first position at which one or more displays of the HMD are positioned in front of eyes of a user to a second position at which the one or more displays are positioned elsewhere with respect to the user; and
generating user representation data corresponding to a three-dimensional (3D) appearance of the person during the period of time, wherein the user representation data is generated based on determining the removal of the HMD during the period of time, wherein a view of the user representation is provided based on the user representation data.

15. The HMD of claim 14, wherein determining removal of the HMD comprises determining that the HMD is being doffed.

16. The HMD of claim 14, wherein determining removal of the HMD comprises:
detecting a change in position or orientation of the HMD based on motion sensor data;
determining a change of user eye position relative to an eye box region of the device; or
detecting that an eye of the user is no longer within an eye box region of the HMD based on eye sensor data.

17. The HMD of claim 14, wherein generating the user representation data based on determining the removal of the HMD during the period of time comprises:
generating the user representation data using current user data prior to the removal; and
generating the representation data without using current user data after the removal.

18. The device of claim 14, wherein, after the removal, the user representation data represents:
a neutral appearance of the user;
a prior appearance of user;
a fixed appearance of the user corresponding to a most recent appearance of the user prior to the removal; or
a fixed appearance of the user corresponding to an appearance of the user prior to the period of time.

19. The device of claim 14, wherein generating the user representation data based on determining the removal of the HMD during the period of time comprises:
providing a gradual change in the user representation data from representing a current user appearance prior to the removal to representing a fixed user appearance after the removal.

20. A non-transitory computer-readable storage medium, storing program instructions executable on a device to perform operations comprising:
one or more processors coupled to the non-transitory computer-readable storage medium, wherein the non-transitory computer-readable storage medium comprises program instructions that, when executed on the one or more processors, cause the one or more processors to perform operations comprising:
obtaining sensor data via the one or more sensors during a period of time;
determining a removal of the HMD during the period of time based on the sensor data, wherein the removal of the HMD corresponds to a change of the HMD from a first position at which one or more displays of the HMD are positioned in front of eyes of a user to a second position at which the one or more displays are positioned elsewhere with respect to the user; and
generating user representation data corresponding to a three-dimensional (3D) appearance of the person during the period of time, wherein the user representation data is generated based on determining the removal of the HMD during the period of time, wherein a view of the user representation is provided based on the user representation data.
